(19) United States
(12) Patent Application Publication
(10) Pub. No.: US 2023/0348660 A1
(43) Pub. Date: Nov. 2, 2023

(54) ALKYL-LINKED POROUS PORPHYRIN POLYMER, AND METHOD OF SEPARATING GAS AND METHOD OF RECOVERING VALUABLE METAL USING SAME

(71) Applicant: KOREA ADVANCED INSTITUTE OF SCIENCE AND TECHNOLOGY, Daejeon (KR)

(72) Inventors: Cafer T. YAVUZ, Daejeon (KR); Yeongran HONG, Daejeon (KR); Vepa ROZYYEV, Daejeon (KR)

(21) Appl. No.: 18/183,489

(22) Filed: Mar. 14, 2023

(30) Foreign Application Priority Data
Apr. 29, 2022 (KR) 10-2022-0053444

(51) Int. Cl. C08G 61/12; B01J 20/22; B01J 20/26

(52) U.S. Cl. CPC C08G 61/124; B01J 20/226; B01J 20/262

(57) ABSTRACT

Disclosed are an alkyl-linked porous porphyrin polymer and gas separation and valuable metal recovery using the same, and more particularly an alkyl-linked porous porphyrin polymer imparted with a large surface area and high microporosity by linking a porphyrin unit with a chlorinated solvent linker, thereby exhibiting excellent adsorption selectivity for valuable metal to thus enable recovery of valuable metal, and also manifesting high performance in a selective gas separation method, and a method of separating gas and a method of recovering valuable metal using the same.

### CROSS-REFERENCE TO RELATED APPLICATION

The priority under 35 USC § 119 of Korean Patent Application 10-2022-0053444 filed Apr. 29, 2022 is hereby claimed, and the disclosure thereof is hereby incorporated herein by reference, in its entirety, for all purposes.

### TECHNICAL FIELD

The present invention relates to an alkyl-linked porous porphyrin polymer, and a method of separating gas and a method of recovering valuable metal using the same, and more particularly to an alkyl-linked porous porphyrin polymer imparted with a large surface area and high microporosity by linking a porphyrin unit with a chlorinated solvent linker, thereby exhibiting excellent adsorption selectivity for valuable metal elements to thus enable recovery of valuable metal elements, and also thereby manifesting high performance in a selective gas separation method, and a method of separating gas and a method of recovering valuable metal elements using the same.

### BACKGROUND ART

Porous polymers have received great attention in recent decades due to the various functions, controllable pore structures, and ease of preparation thereof. Porous polymers having these characteristics have been studied in a variety of applications such as gas separation, metal adsorption, water purification, catalysis, photocatalysis, and energy storage (J. Wu et al., Adv. Mater. 2019, 31, 1802922; B. Zheng et al., Adv. Funct. Mater. 2020, 30, 1907006; H. A. Patel et al., ChemSusChem 2017, 10, 1303; Y. Zhao et al., RSC Adv. 2015, 5, 30310; P. Nugent et al., Nature 2013, 495, 80; N. P. Wickramaratne et al., J. Mater. Chem. A 2013, 1, 112). Porphyrins are readily available and unique building blocks for constructing functional and scalable porous networks, but are rarely used. The porphyrin ring structure is composed of four pyrroles and is capable of providing a strong adsorption site for both gas molecules and metal ions (S. Kumar et al., J. Mater. Chem. A 2015, 3, 19615; M. M. Pereira et al., ACS Catal. 2018, 8, 10784; S. Ma et al., J. Am. Chem. Soc. 2008, 130, 1012; B. Li et al., J. Am. Chem. Soc. 2014, 136, 6207; J. Son et al., Total Environ. 2020, 704, 135405; D. Dolphin, The Porphyrins, Academic Press, New York 1978). In gas separation applications, porphyrin pyrrolic nitrogen offers enhanced binding for CO₂ (S. Ma et al., J. Am. Chem. Soc. 2008, 130, 1012; Y. Xia et al., J. Mater. Chem. A 2013, 1, 9365; K. C. Park et al., RSC Adv. 2016, 6, 75478; Z. Wang et al., Macromolecules 2012, 45, 7413). Recent studies focused thereon have disclosed a porphyrin-based conjugated microporous polymer (CMP) having an azide group (D. Cui et al., Chem. Comm. 2017, 53, 11422), a porphyrin- and pyrene-based CMP (Por-Py-CMP) (K. C. Park et al., RSC Adv. 2016, 6, 75478), a triazine-functionalized porphyrin-based porous organic polymer (TPOP-1) (A. Modak et al., J. Mater. Chem. A 2014, 2, 11642), and a 3D Mn (II)-porphyrin metal-organic framework (MOF) (N. Sharma et al., Chem. Eur. J. 2018, 24, 16662). Porphyrin-based porous structures also exhibit the ability to store hydrogen (H₂) gas (Y. Xia et al., J. Mater. Chem. A 2013, 1, 9365; A. Ahmed et al., Nat. Commun. 2019, 10, 1; J. Xia et al., Macromolecules 2010, 43, 3325). Polyporphyrins having a large surface area (e.g. 1500 m²/g or more) and functionalized with thiophenyl groups showed a 5% mass increase after H₂ adsorption at 77 K and 65 bar (J. Xia et al., Macromolecules 2010, 43, 3325). However, the extensive development effort required to realize such performance has highlighted the need to realize the complex functions of porphyrins in an economically feasible manner (H. A. Patel et al., Faraday Discuss. 2015, 183, 401).

In general, porous polymers are also emerging as selective adsorbents for recovering metals from wastewater (N. A. Dogan et al., ACS Sustain. Chem. Eng. 2018, 7, 123; T. S. Nguyen et al., Chem. Mater. 2020, 32, 5343; Y. Yue et al., Ind. Eng. Chem. Res. 2016, 55, 4125; Y. H. Sihn et al., RSC Adv. 2016, 6, 45968). Valuable metals such as gold, platinum, palladium, and silver are promising objects for metal recovery because of the high value and widespread use thereof in chemical industries (A. Akcil et al., Waste Manage. 2015, 45, 258; C. Yue et al., Angew. Chem., Int. Ed. 2017, 129, 9459). These metals may be recovered from electronic waste (e-waste), which is called urban mining (B. K. Reck et al., Science 2012, 337, 690; M. P. O'Connor et al., ACS Sustain. Chem. Eng. 2016, 4, 5879). The amount of e-waste is expected to reach 74 million tons a year in 2030, and valuable metals will become even more important because high-tech products increasingly need these metals (V. Forti et al., The Global E-waste Monitor 2020: Quantities, flows and the circular economy potential, United Nations University (UNU)/United Nations Institute for Training and Research (UNITAR)—co-hosted SCYCLE Programme, International Telecommunication Union (ITU)/International Solid Waste Association (ISWA), Bonn/Geneva/Rotterdam 2020; E. Hsu et al., Green Chem. 2019, 21, 919; J. Cui et al., J. Hazard. Mater. 2008, 158, 228). Some nonporous adsorbents were developed in order to obtain high adsorption capacity for valuable metals, particularly gold, but the selectivity thereof was tested using only a few metals, and unsatisfactory results appeared for other criteria such as adsorption rate and ease of desorption (Y. Li et al., Green Chem. 2014, 16, 4875; M. Gurung et al., Chem. Eng. J. 2011, 174, 556; B. Pangeni et al., Green Chem. 2012, 14, 1917; H. Akbulut et al., RSC Adv. 2016, 6, 108689). This is not satisfactory for practical e-waste applications, so more suitable adsorbents have to be developed. Porous polymers having customizable functions and large contact areas are expected to solve these problems. In a previous study by the present inventors, amidoxime-functionalized polymers known to be active on uranium ions (C. W. Abney et al., Chem. Rev. 2017, 117, 13935; Z. Wang et al., Chem 2020, 6, 1683) were studied for gold recovery (N. A. Dogan et al., Chem. Eng. 2018, 7, 123). The nitrile group in the polymer may be modified to an amidoxime group without losing the porosity of the polymer, making it possible to compare functional effects on metal adsorption. The amidoxime group was found to be a more effective adsorption site for gold than the nitrile group but less effective in view of metal selectivity when compared to chelating substrates such as porphyrins. Although porous polymers having porphyrin building blocks have recently been used for valuable metal capture (Y. Hong et al., Proc. Natl. Acad. Sci. U.S.A. 2020, 117, 16174), more convenient and industrially feasible methods are required due to the use of two synthesis steps and low yield of the prepared polymer.

Therefore, the present inventors have made great efforts to prepare inexpensive and scalable porphyrin-based covalent organic polymers (COPs) for valuable metal capture and gas separation, and ascertained that porphyrin-based covalent organic polymers, in which porphyrin units are linked through a rapid one-pot Friedel-Crafts (FC) reaction of a porphyrin monomer with each of three different chlorinated solvents, namely dichloromethane, chloroform, and 1,2-dichloroethane, are synthesized, and the polymers thus synthesized have large surface areas and high microporosity, thereby exhibiting high adsorption selectivity for precious metals such as gold, platinum, palladium, and silver in mixed metal tests using acidic solutions of 30 different metals, making it possible to recover valuable metals, and also thereby showing high selectivity for carbon dioxide (CO₂), methane (CH₄), and hydrogen (H₂), making it applicable to a selective gas separation method, thus culminating in the present invention.

### SUMMARY OF THE INVENTION

It is an object of the present invention to provide a porous porphyrin polymer exhibiting high selectivity for valuable metals and excellent performance in selective gas separation, and a method of preparing the same.

It is another object of the present invention to provide a method of selectively adsorbing a valuable metal element in a precious-metal-containing solution using the porous porphyrin polymer and recovering the adsorbed valuable metal element and polymer adsorbent again.

All of the above objects of the present invention can be accomplished by the present invention described below.

In order to accomplish the above objects, the present invention provides a porphyrin-based covalent organic polymer represented by Chemical Formula 1, Chemical Formula 2, or Chemical Formula 3 below:

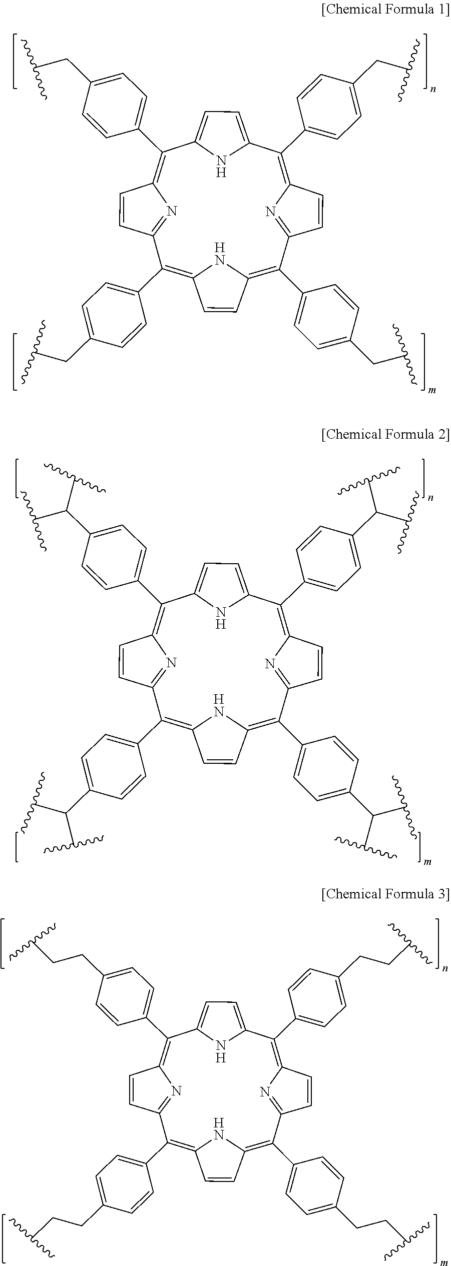

in Chemical Formula 1, Chemical Formula 2, and Chemical Formula 3, m and n are numbers of repeating units, m is an integer from 500 to 400,000, and n is an integer from 500 to 400,000.

In addition, the present invention provides a method of preparing the porphyrin-based covalent organic polymer described above, including adding a tetraphenylporphyrin monomer and a chlorinated solvent in the presence of a Lewis acid catalyst and performing a Friedel-Crafts polymerization reaction to obtain a porous covalent organic polymer represented by Chemical Formula 1, Chemical Formula 2, or Chemical Formula 3.

In addition, the present invention provides an adsorbent including the porphyrin-based covalent organic polymer described above or the porphyrin-based covalent organic polymer in which a metal is loaded.

In addition, the present invention provides a method of recovering a valuable metal element from a precious-metal-containing solution, including (a) adsorbing a valuable metal element to the adsorbent by adding the adsorbent comprising the porphyrin-based covalent organic polymer to a solution containing the valuable metal element; and (b) desorbing and recovering the valuable metal element from the dsorbent to which the valuable metal element is adsorbed.

In addition, the present invention provides a method of separating carbon dioxide, methane, or hydrogen from a mixture including carbon dioxide (CO₂), methane (CH₄), and hydrogen (H₂) by contacting the adsorbent described above with the mixture including carbon dioxide (CO₂), methane (CH₄), and hydrogen (H₂).

### BRIEF DESCRIPTION OF THE DRAWINGS

The above and other objects, features, and other advantages of the present invention will be more clearly understood from the following detailed description taken in conjunction with the accompanying drawings, in which:

FIG. 1 in A to E therein shows synthesis of alkyl-linked porphyrin-based COPs according to an embodiment of the present invention, A showing synthesis schemes and photos of the products, B showing argon adsorption and desorption isotherms at 87 K, C showing pore size distribution using NLDFT calculation, D showing FT-IR spectra, and E showing TGA results in ambient and nitrogen atmospheres for COP-210, COP-211, and COP-212;

FIG. 2 in A to I therein shows gas uptake of COPs according to an embodiment of the present invention, including carbon dioxide uptake at 273 K and 298 K of COP-210 (A), COP-211 (B), and COP-212 (C), methane uptake at 273 K and 298 K of COP-210 (D), COP-211 (E), and COP-212 (F), hydrogen uptake of COP-210, COP-211, and COP-212 at 77 K (G), Qₛₜ calculation for CO₂ uptake of COPs (H), and Qₛₜ calculation for CH₄ uptake of COPs (I);

FIG. 3 in A to C therein shows the results of spectroscopic analysis of metal-loaded COPs according to an embodiment of the present invention, A showing powder XRD patterns of COP-210 loaded with each of copper, silver, palladium, platinum, and gold, and COP-210 not loaded with any metal, B showing XPS spectra of gold (4f) of gold-loaded COPs, and C showing XPS spectra of platinum (4f) of platinum-loaded COPs, in which, in the XRD pattern of COP-210-Ag, the diamond symbol (⋄) and the filled circle symbol (●) represent silver chloride and silver nanoparticles, respectively;

FIG. 4 in A to I therein shows gold adsorption and desorption by COPs according to an embodiment of the present invention, including gold adsorption isotherms of COP-210 (A), COP-211 (B), and COP-212 (C), time-dependent changes in gold concentration of COP-210 (D), COP-211 (E), and COP-212 (F) at various pHs, and desorption efficiencies in three iterative adsorption-desorption processes of COP-210 (G), COP-211 (H), and COP-212 (I);

FIG. 5 shows gold recovery from an actual e-waste solution using COP-212 according to an embodiment of the present invention;

FIG. 6 in A to I therein shows the results of metal selectivity testing according to an embodiment of the present invention, in which COP-210 was tested in standard solution 1 (A), standard solution 2 (B), and a mixture of standard solution 1 and standard solution 2 (C), COP-211 was tested in standard solution 1 (D), standard solution 2 (E), and a mixture of standard solution 1 and standard solution 2 (F), and COP-212 was tested in standard solution 1 (G), standard solution 2 (H), and a mixture of standard solution 1 and standard solution 2 (I);

FIG. 7 in A and B therein showa XRD patterns of COP-211 (A) and COP-212 (B) on which copper, silver, palladium, platinum, and gold are adsorbed according to an embodiment of the present invention, compared to COP-211 and COP-212 not loaded with any metal, in which, in the XRD patterns of COP-211-Ag and COP-212-Ag, the diamond symbol (⋄) and the filled circle symbol (●) represent silver chloride and silver nanoparticles, respectively;

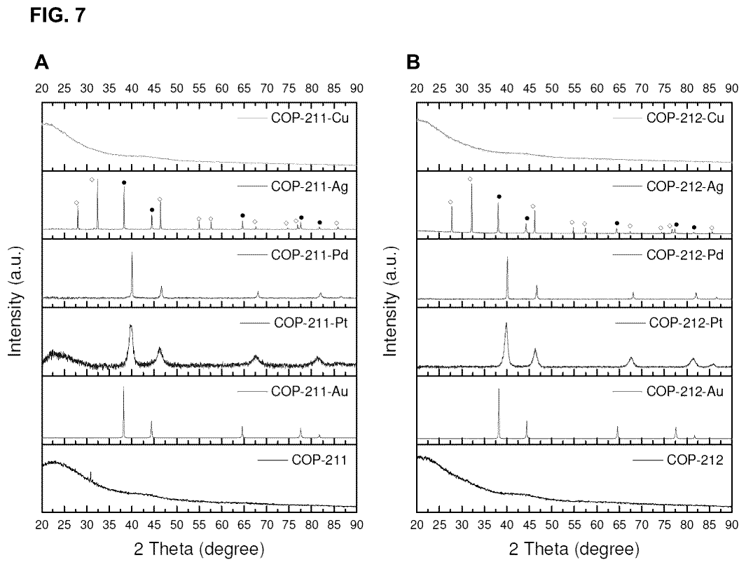

FIG. 8 in A to C therein shows FT-IR spectra of COP-210 (A), COP-211 (B), and COP-212 (C) after three gold adsorption and desorption cycles compared to pristine COPs;

FIG. 9 in A to C therein shows TEM and STEM images of COP-210 (A), COP-211 (B), and COP-212 (C), each of which was loaded with gold;

FIG. 10 in A to H therein shows graphs showing changes in UV/Vis absorption after addition of a porphyrin solution to a copper solution (A), a gold solution (B), a platinum solution (C), a palladium solution (D), an iron solution (E), a cobalt solution (F), a nickel solution (G), and a zinc solution (H);

FIG. 11 is a graph showing the ICP-MS aluminum concentration before and after treatment with COP-210, COP-211, and COP-212; and

FIG. 12 in A to G therein shows SEM (scanning electron microscope) images of COP-210, COP-211, and COP-212.

### BEST MODE FOR CARRYING OUT THE INVENTION

Unless otherwise defined, all technical and scientific terms used herein have the same meanings as those typically understood by those skilled in the art to which the present invention belongs. In general, the nomenclature used herein is well known in the art and is typical.

In the present invention, an inexpensive and scalable porphyrin-based covalent organic polymer (COP) for valuable metal capture and gas separation was prepared. Specifically, three porous polymers, namely COP-210, COP-211, and COP-212, in which porphyrin units are linked through a one-pot Friedel-Crafts (FC) reaction of porphyrin monomers with respective linkers, namely dichloromethane, chloroform, and 1,2-dichloroethane, have large surface areas and high microporosity, thus exhibiting high adsorption selectivity for valuable metals such as gold, platinum, palladium, and silver in mixed metal tests using acidic solutions of 30 different metals, and high selectivity for carbon dioxide (CO₂), methane (CH₄), and hydrogen (H₂), thereby confirming applicability thereof to selective gas separation and recovery of valuable metal elements from metal leachate of e-waste, river water, or seawater.

Accordingly, an aspect of the present invention pertains to a porphyrin-based covalent organic polymer represented by Chemical Formula 1, Chemical Formula 2, or Chemical Formula 3 below.

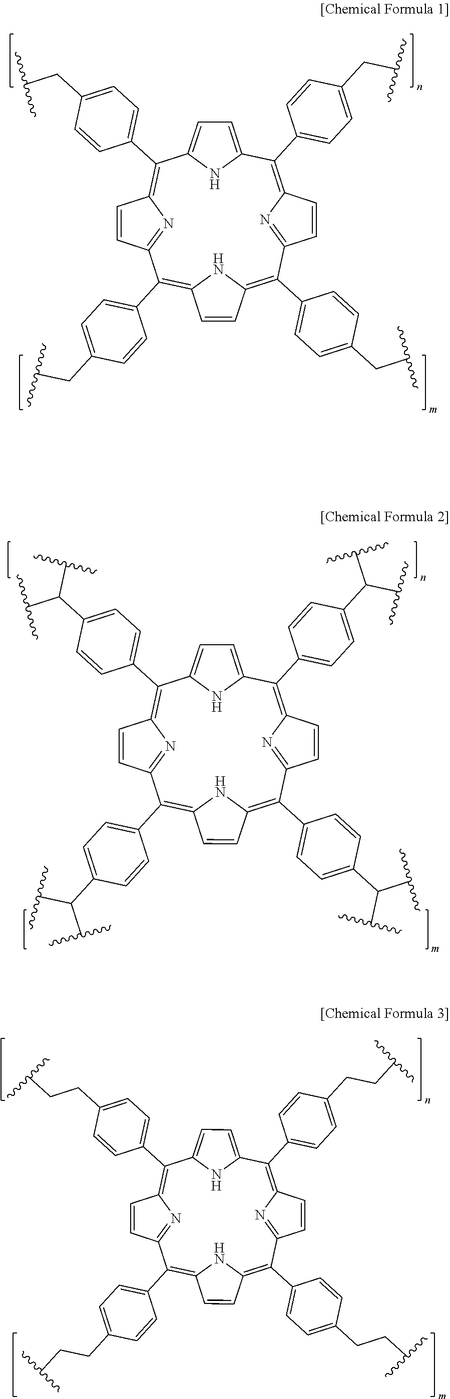

In Chemical Formula 1, Chemical Formula 2, and Chemical Formula 3, m is an integer of 500 to 400,000, and n is an integer of 500 to 400,000.

In Chemical Formula 1, respective repeating units (monomers) of Chemical Formula 1 are bound to

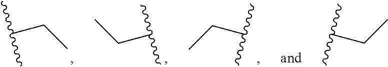

to obtain a polymer 500 to 400,000 monomers long.

Also, in Chemical Formula 2, respective repeating units (monomers) of Chemical Formula 2 are bound to

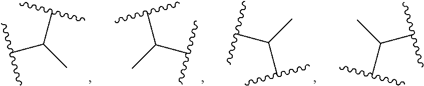

to obtain a polymer 500 to 400,000 monomers long.

Also, in Chemical Formula 3, respective repeating units (units) of Chemical Formula 3 are bound to

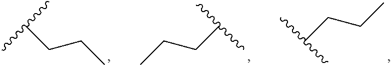

and

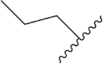 [SMILES: *CCC]

to obtain a polymer 500 to 400,000 monomers long.

For example, when two repeating units are further bound thereto, the resulting product may be represented as follows.

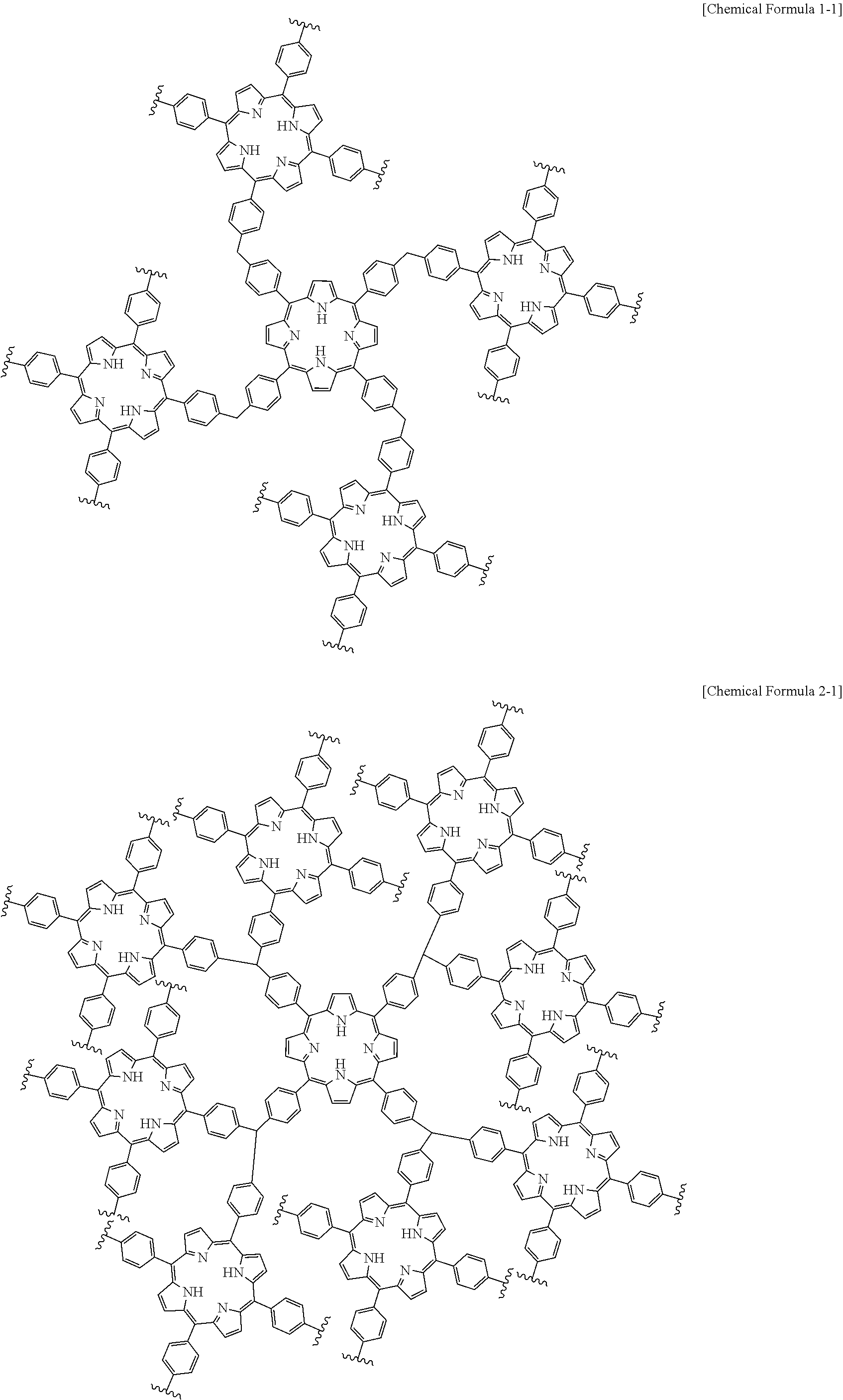

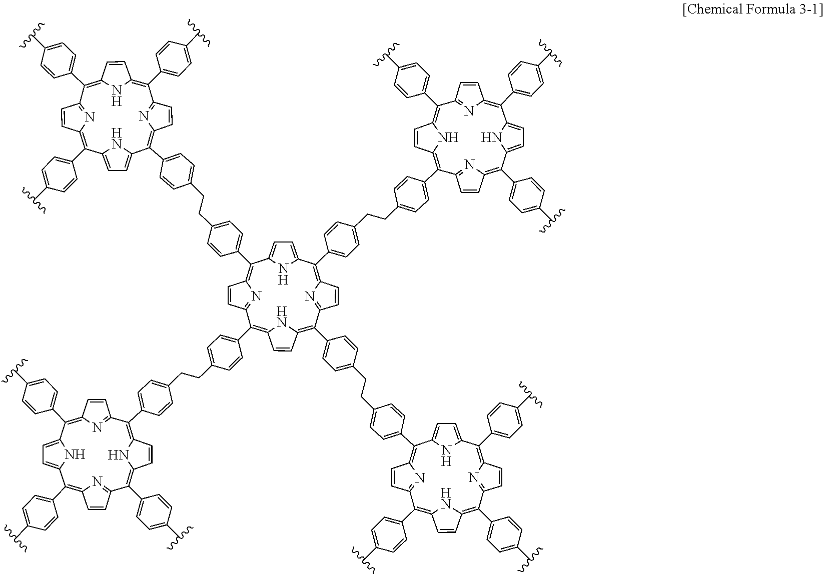

From the structures of Chemical Formulas 1-1, 2-1, and 3-1, it can be seen how repeating units are bound in Chemical Formula 1, Chemical Formula 2, and Chemical Formula 3 to form a polymer structure.

Since the linking groups are the same in the four directions in which the linker is connected to porphyrin, n and m have the same values in the range of 500 to 400,000. Moreover, when the time taken to synthesize the polymer is decreased or increased from the existing 48 hours, the polymer may be synthesized while controlling n and m.

Since the main adsorption site for metal ion adsorption is porphyrin, similar or identical effects will be obtained even for polymers having lower n and m values. Moreover, since porosity is necessary for gas adsorption, n has to be 500 or more in the polymer.

The porphyrin-based covalent organic polymer according to the present invention has a specific surface area of 500-856 m²/g, a microporosity of 84-92%, a particle size of 100 nm-1,000 and a pore size of 0-6 nm.

It was confirmed that the porphyrin-based covalent organic polymer according to the present invention is stable up to 330° C. in ambient and nitrogen atmospheres, and thus also exhibits thermal durability.

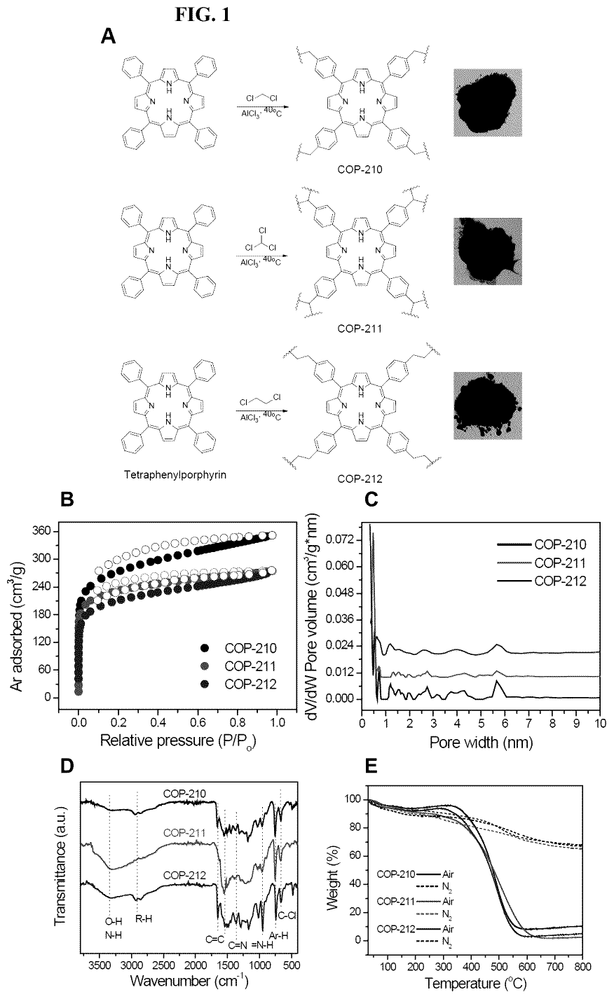

FC alkylation is the most promising synthesis method for making porous networks with C—C bonding frameworks due to the availability of precursors and reagents (P. Jorayev et al., ChemSusChem 2020, 13, 6433). Three different porphyrin-based COPs were synthesized using FC alkylation polymerization. The synthesis was based on the previous solvent-linked FC polymerization method (V. Rozyyev et al., Nat. Energy 2019, 4, 604). A polymer was prepared at low cost using a commercially available monomer such as meso-tetraphenylporphyrin, aluminum chloride (AlCl₃), and a chlorinated solvent. The synthesis proceeds in a single step under mild reaction conditions (room temperature or 40° C., usually no heating required because of exothermic reaction) including exposure to the atmosphere. The chlorinated solvents, namely DCM, CHCl₃, and DCE, serve as linkers and solvents, yielding three different polymers, designated COP-210, COP-211, and COP-212, respectively (FIG. 1 in A to E therein). Due to the formation of highly reactive intermediates such as benzyl chloride and the use of strong AlCl₃ Lewis acid, the reaction proceeds to formation of polymers. The porous polymers were obtained at yields of at least 80-90%. The products are insoluble in typical solvents and stable under air and moisture, making them easy to work and purify.

Three novel porphyrin-based porous polymers may be prepared using a one-step easily scalable synthesis method. Commercial tetraphenylporphyrin reacted separately with three reagents, namely DCM, CHCl₃, and DCE, which serve as both linkers and solvents. The porphyrin unit and the reagent were linked via C—C bonding through a Friedel-Crafts reaction. The developed polymers were porous (685-856 m²/g SABET) and most pores were micropores. In gas uptake tests, porphyrin-based porous polymers showed increased CO₂ uptake (3.01-4.30 mmol/g at 273 K and 1.1 bar) with an increase in surface area due to the contribution of physisorption. Similarly, the polymers adsorbed more H₂ (7.11-8.88 mmol/g) due to the higher surface area thereof. For CH₄ uptake, COP-211, having a lower surface area and Qₛₜ value, exhibited the highest CH₄ uptake capacity due to the highly crosslinked tridentate linker. Meanwhile, COPs may be utilized for valuable metal recovery. The polymers were found to more selectively adsorb valuable metals such as gold, platinum, palladium, silver, copper, and the like than other general metals. Based on gold adsorption capacities of 1.176, 0.901, and 1.250 g/g, the polymers exhibited fast gold adsorption kinetics at low pH. The adsorbed gold was easily desorbed under mild desorption conditions, and the adsorption capability of the polymers was maintained in three repeated adsorption and desorption processes. COPs exhibited industrially viable gas and metal adsorption performance, and were scalable and inexpensive, proving that these polymers are promising materials for both applications. For example, COP-212 was applied to metal leachate of actual e-waste. COP-212 is capable of recovering 95.6% of gold even when the concentration of gold in the metal leachate is much lower than other metals.

Another aspect of the present invention pertains to a method of preparing the porphyrin-based covalent organic polymer described above, including adding a tetraphenylporphyrin monomer and a chlorinated solvent in the presence of a Lewis acid catalyst and performing a Friedel-Crafts polymerization reaction to afford a porous covalent organic polymer represented by Chemical Formula 1, Chemical Formula 2, or Chemical Formula 3.

In the preparation method of the present invention, 2,000 to 3,000 parts by weight of the chlorinated solvent may be added based on 100 parts by weight of the tetraphenylporphyrin monomer.

When the amount of the chlorinated solvent falls within the above range, a solvent-linked polymer may be effectively formed.

The Lewis acid catalyst may be aluminum chloride (AlCl₃), but any material may be used without limitation, so long as it is capable of serving as a Lewis acid catalyst causing a Friedel-Crafts alkylation reaction of a monomer and a chlorinated solvent.

In the present invention, the chlorinated solvent may be dichloromethane, chloroform, or 1,2-dichloroethane, but is not limited thereto.

In the present invention, the excess chlorinated solvent is responsible for two roles: a linker connecting the monomer and a solvent.

In the present invention, the reaction may be carried out at 20-85° C. for 24-72 hours.

In the present invention, the one-pot polymerization reaction is a synthesis operation in which, when synthesizing a target compound through a reaction process of two steps or more, the target compound is obtained by continuously adding and reacting the reactants for the next step to the same reaction vessel, without isolating and purifying the product (intermediate product) of each step during the process. Since it is possible to avoid material loss attributable to isolation and purification of intermediate products, total yield is typically improved compared to the method of isolating and purifying intermediate products one by one and proceeding to the next step, so long as the byproducts do not interfere with the reaction of the next step.

The porphyrin-based covalent organic polymer according to the present invention has excellent selectivity for gold, platinum, palladium, silver, and copper metal ions in a mixed solution of various metal ions, and has high adsorption efficiency across almost the entire pH range, indicating that, when applied to metal leachate of e-waste and seawater, gold, platinum, palladium, silver, or copper metal ions were adsorbed and recovered with higher selectivity than other metals.

Still another aspect of the present invention pertains to an adsorbent including the porphyrin-based covalent organic polymer or the porphyrin-based covalent organic polymer in which a metal is loaded.

Yet another aspect of the present invention pertains to a method of recovering a valuable metal element from a precious-metal-containing solution including (a) adsorbing a valuable metal element to the adsorbent by adding the adsorbent including the porphyrin-based covalent organic polymer to a solution containing the valuable metal element, and (b) desorbing and recovering the valuable metal element from the adsorbent to which the valuable metal element is adsorbed.

In step (b), the adsorbent to which the valuable metal element is adsorbed may be added to a mixed solution of acid and thiourea in order to desorb the valuable metal element.

The method may further include, after step (b), recirculating the adsorbent from which the valuable metal is desorbed to step (a).

When step (a) is performed through irradiation with light, it is possible to increase the valuable metal element adsorption capacity.

The precious-metal-containing solution may be seawater or wastewater from a plating plant.

Still yet another aspect of the present invention pertains to a method of recovering a valuable metal element from e-waste including (a) removing a coating film from the substrate of the e-waste, (b) soaking the substrate from which the coating film is removed in an acid solution and performing filtration, (c) adding a basic solution and desalted water to the filtered solution and then adding the adsorbent including the porphyrin-based covalent organic polymer thereto to adsorb a valuable metal element, and (d) desorbing and recovering the valuable metal element from the adsorbent to which the valuable metal element is adsorbed.

The valuable metal may be selected from the group consisting of Au, Pt, Ag, Pd, Ru, Rh, Ir, Cu, and Re.

The pH of the solution may fall within a wide range of 2-9.

When step (c) is performed through irradiation with light, it is possible to increase the valuable metal element adsorption capacity.

In step (d), the adsorbent to which the valuable metal element is adsorbed may be added to an acid solution in order to desorb the valuable metal element.

The method may further include, after step (d), recirculating the adsorbent from which the valuable metal is desorbed to step (a).

A further aspect of the present invention pertains to a method of separating carbon dioxide, methane, and hydrogen from a mixture including carbon dioxide (CO₂), methane (CH₄), and hydrogen (H₂) by contacting the adsorbent including the porphyrin-based covalent organic polymer or metal-loaded porphyrin-based covalent organic polymer with the mixture including carbon dioxide (CO₂), methane (CH₄), and hydrogen (H₂).

A better understanding of the present invention may be obtained through the following examples. These examples are merely set forth to illustrate the present invention, and are not to be construed as limiting the scope of the present invention, as will be apparent to those of ordinary skill in the art.

### EXAMPLES

### Example 1: Synthesis of Covalent Organic Polymer

Meso-tetraphenylporphyrin was purchased from Alfa Aesar. Gold (III) chloride trihydrate (HAuCl₄·3H₂O,, ≥99.9%), copper chloride (CuCl₂, 99.999%), and 5, 10, 1 5 ,20-tetra(4-pyridyl)-21H,23H-porphine were obtained from Merck. Dichloromethane (DCM, 99.5%), chloroform (CHCl₃, 99.5%), 1,2-dichloroethane (DCE, 99.0%), methanol, hydrochloric acid (35.0-37.0%), nitric acid (68.0-70.0%), thiourea, silver nitrate (AgNO3, 99.8%), cobalt chloride hexahydrate (CoCl₂.6H₂O, 97.0%), and nickel chloride hexahydrate (NiCl₂·6H₂O, 97.0%) were purchased from Samchun. Anhydrous aluminum (III) chloride (AlCl₃. 95%) was purchased from Junsei. Potassium tetrachloroplatinate (II) (K₂PtCl₄, 46-47% Pt) and potassium tetrachloropalladate (II) (K₂PdCl₄, minimum 32.0% Pd) were purchased from Acros Organics. All solvents were used without purification. For all metal adsorption and desorption tests, deionized water (DIW) obtained from a MiliQ (18.2 MQcm at 25° C.) system was used.

### Example 1-1: Synthesis of COP-210

COP-210 was prepared according to the following procedure. 500 mg of meso-tetraphenylporphyrin was placed in a 30 mL glass vial. Then, 672 mg of AlCl₃, 10 mL of DCM, and a stirring bar were placed in the vial. The reaction mixture was heated to 40° C., capped, and stirred for 48 hours (it is to be noted that HCl pressure may build up in the vial). After 48 hours, the reaction was quenched by slowly adding 10 mL of methanol (it is to be noted that the reaction between AlCl₃ and methanol is very exothermic), and the solid was filtered and washed with methanol and chloroform (10 mL each). The resulting solid was sonicated for 30 minutes and soaked in 6 M HCl (18% HCl in methanol) overnight. The product was then washed in a Soxhlet extractor with 100 mL of chloroform and 100 mL of methanol for 24 hours each. After washing, the product was dried at 100° C. in a vacuum for 12 hours. The yield was 490 mg.

### Examples 1-2: Synthesis of COP-211

COP-211 was synthesized in the same manner as in Example 1-1, with the exception that 10 mL of chloroform was used for synthesis of COP-211, in lieu of dichloromethane in the synthesis of COP-210 of Example 1-1. 510 mg of COP-211 was obtained as a final product.

### Examples 1-3: Synthesis of COP-212

COP-212 was synthesized in the same manner as in Example 1-1, with the exception that 10 mL of dichloroethane was used for synthesis of COP-212, in lieu of dichloromethane in the synthesis of COP-210 of Example 1-1. 570 mg of COP-212 was obtained as a final product.

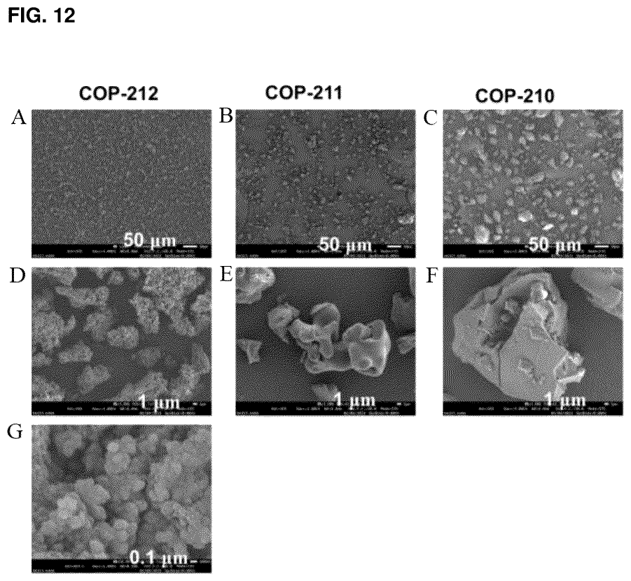

The porosity of porphyrin-based COPs was analyzed based on argon adsorption and desorption isotherms at 87 K. The materials showed high Brunauer-Emmett-Teller (BET) surface areas (685-856 m²/g) with predominantly microporous morphology (84-92%). Among these COPs, DCM-linked COP-210 exhibited the highest surface area of 856 m²/g (Table 1). NLDFT (nonlocal density functional theory) pore size distribution analysis using a slit pore model confirmed the major microporous structures of the materials (FIG. 1 in A to E therein). Chloroform-linked COP-211 exhibited the highest microporosity, accounting for 92% of the total pore volume. Here, higher microporosity is deemed to be due to higher crosslinking of tridentate linker CHCl₃ compared to bidentate linkers (DCM and DCE). The DCE-linked polymer showed the lowest surface area (685 m²/g) and microporosity (84%) among the three structures, which may be explained by the flexible properties of the dimethylene linker, lacking a rigid backbone, for the formation of a modified network. The results for the porous polymers in Examples described above are consistent with the results of a previous study by the present inventors (V. Rozyyev et al., Nat. Energy 2019, 4, 604). The morphology of COPs was analyzed using scanning electron microscopy (SEM), and the results thereof are shown in FIG. 12 in A to G therein. As shown in SEM images, the particles of COP-210 are mainly flat, and COP-212 is spherical, but COP-211 varies from flat to spherical particles (FIG. 12 in A to G therein). COP-212 showed a much smaller particle size (100 nm) than COP-211 (5 μm) and COP-210 (25 μm). This indicates that most of the surface area of COP-210 and COP-211 is attributable to the intrinsic porosity thereof, but that COP-212 shows a remarkable amount of void space between particles, thus inadvertently contributing to porosity. Fourier transform infrared spectroscopy (FT-IR) analysis of COPs revealed characteristic porphyrin bands at 1365 cm⁻¹ (C═N) and 954 cm⁻¹ (N—H), 1500-1650 cm⁻¹ and 740 cm⁻¹ (Ar—H), and aliphatic linker bands at 2700-3000 cm^{31 1}, indicating the successful formation of porphyrin-based network polymers. Also, the presence of C—Cl stretching at 665 cm⁻¹ shows the dangling unreacted linker from the solvent. Thermogravimetric analysis (TGA) of COPs under nitrogen and ambient atmospheres showed thermal stability up to 330° C. Desorption of adsorbed water and solvent (up to about 150° C. and 20% of mass loss) also confirmed the high porosity of the materials (FIG. 1 in A to E therein).

TABLE 1
Measurement of porosity and gas adsorption capability
of COP-210, COP-211, and COP-212

| | [symbol] | [symbol] | [symbol] | [symbol] | [symbol] | [symbol] | [symbol] | [symbol] |
|---|---|---|---|---|---|---|---|---|
| Sample | [symbol] | [symbol] | [symbol] | [symbol] | [symbol] | [symbol] | [symbol] | [symbol] |
| COP-210 | 856 | 0.445 | 0.376 | 4.30 | 2.85 | 1.33 | 0.74 | 8.38 |
| COP-211 | 769 | 0.368 | 0.341 | 3.47 | 2.21 | 1.44 | 0.79 | 8.24 |
| COP-212 | 685 | 0.324 | 0.279 | 3.01 | 1.86 | 1.30 | 0.66 | 7.11 |

[symbol]

indicates data missing or illegible when filed

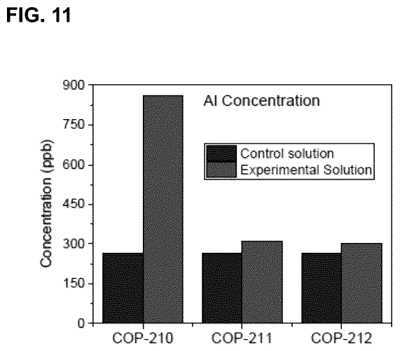

The elemental composition of COPs was measured through combustion (CHNS) analysis, and the results thereof are shown in Table 2 below. The carbon-to-nitrogen ratio in the elemental analysis indicates that single-carbon-linked COP-210 and COP-211 have 6 additional carbons per tetraphenylporphyrin monomer (50:4). Because DCE has two carbons per molecule, DCE-linked COP-212 has 13.7 additional carbons (57.7) per tetraphenylporphyrin monomer. The higher hydrogen-to-nitrogen ratio of COP-212 also supports this finding. In addition, all COPs indicate the amounts of elements other than carbon, nitrogen, and hydrogen. This is attributable to the remaining AlCl₃ catalyst, unreacted dangling alkyl chloride, and the hydrolyzed form. This finding is supported by the presence of C—Cl and O—H stretching in FT-IR measurement and the remaining mass (Al₂O₃) after ambient TGA. Despite washing with a concentrated HCl solution and Soxhlet washing with methanol, COPs contain residual aluminum. The remaining mass (Al₂O₃) of ambient TGA is 0.9% for COP-211, 1.5% for COP-212, and 4.3% aluminum for COP-210. This may be due to the higher surface area of COP-210. Inductively coupled plasma mass spectrometry (ICP-MS) showed that remaining Al leached out during valuable metal adsorption experiments, indicating that it was replaced with strongly binding metal ions (FIG. 11).

TABLE 2
(a)

| | C | N | H | Al* | C at. Ratio | N at. Ratio | H at. Ratio |
|---|---|---|---|---|---|---|---|
| Sample | (%) | (%) | (%) | (%) | (Theoretical) | (Theoretical) | (Theoretical) |
| COP-210 | 73.58 | 6.86 | 4.11 | 4.29 | 50.0 (46) | 4 (4) | 33.55 (30) |
| COP-211 | 68.25 | 6.31 | 3.65 | 0.89 | 50.4 (45.33) | 4 (4) | 32.13 (27.33) |
| COP-212 | 73.70 | 5.96 | 4.39 | 1.54 | 57.7 (48) | 4 (4) | 41.25 (34) |
| Meso-Tetraphenyl | 85.97 | 9.11 | 4.92 | 0 | 44 | 4 | 30 |
| porphine | | | | | | | |

(b)

| Sample | C | N | H | O | Metal |
|---|---|---|---|---|---|
| COP-210-Au | 41.37 | 3.30 | 3.11 | 9.40 | 30.61 |
| COP-211-Au | 43.28 | 4.01 | 2.47 | 8.66 | 31.73 |
| COP-212-Au | 50.27 | 4.14 | 3.21 | 7.28 | 30.03 |
| COP-210-Pt | 58.48 | 4.90 | 3.46 | 13.11 | 8.50 |
| COP-211-Pt | 59.50 | 5.39 | 3.43 | 10.47 | 9.34 |
| COP-212-Pt | 62.93 | 5.05 | 3.84 | 10.50 | 12.06 |
| COP-210-Pd | 59.71 | 4.59 | 3.27 | 9.83 | 11.37 |
| COP-211-Pd | 58.79 | 4.75 | 2.97 | 9.75 | 10.88 |
| COP-212-Pd | 65.38 | 4.96 | 3.59 | 7.94 | 9.77 |
| COP-210-Ag | 60.11 | 4.81 | 3.26 | 9.70 | 8.92 |
| COP-211-Ag | 60.71 | 5.41 | 3.34 | 12.06 | 8.65 |
| COP-212-Ag | 66.17 | 5.19 | 3.91 | 9.19 | 8.89 |
| COP-210-Cu | 68.40 | 5.88 | 3.92 | 10.78 | 2.93 |
| COP-211-Cu | 68.15 | 6.22 | 3.78 | 10.59 | 1.37 |
| COP-212-Cu | 72.45 | 5.94 | 4.25 | 8.40 | 2.17 |

*Al content was determined based on the remaining mass (Al₂O₃) after ambient TGA.
(a) Elemental composition (%) of COP-210, COP-211, and COP-212,
(b) Elemental composition (%) of metal-loaded COP-210, COP-211, and COP-212

### Example 2: Metal Capture of COP

Single Metal Uptake Study

Metal salts (HAuCl₄·3H₂O, K₂PtCl₄, K₂PdCl₄, AgNO₃, and CuCl₂) were separately dissolved in DIW to prepare 50 mL of a 3000 ppm stock solution of each metal. 500 mg of each COP was added to the metal solution. After the resulting mixture was stirred at 8 rpm for 48 hours, the COP was separated by filtration and washed thoroughly with DIW. The metal-adsorbed COP was dried in air and then further dried in a vacuum oven at 100° C. overnight.

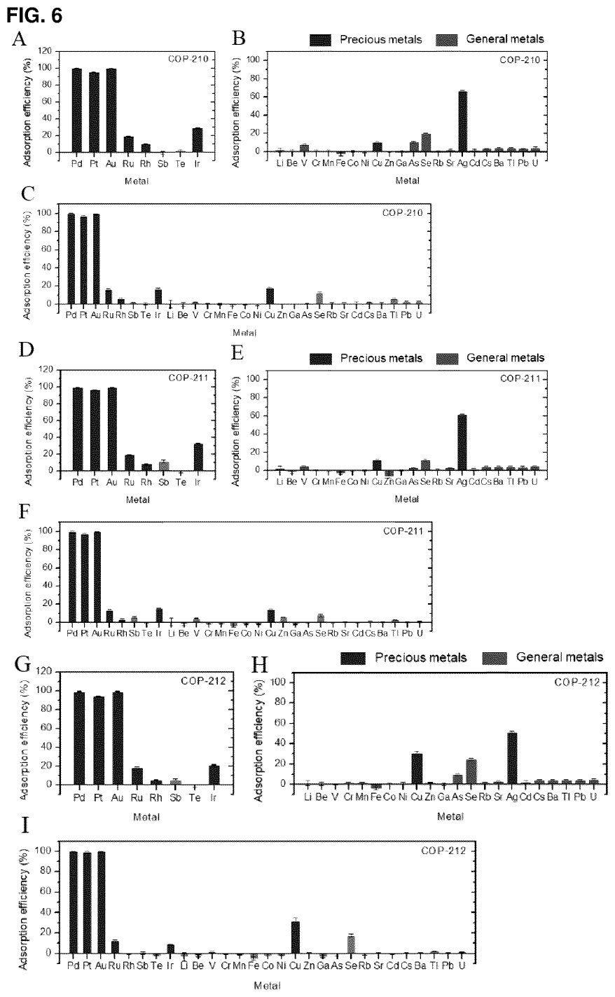

Since solutions almost always contain competing metals, metal binding selectivity in metal capture is one of the important properties of adsorbents, along with adsorption capacity, kinetics, and recyclability. In order to investigate the metal selectivity of the novel COP, a rapid test method (Y. Hong et al., Proc. Natl. Acad. Sci. U.S.A. 2020, 117, 16174) was developed in advance using commercial standard solutions including common elements and valuable metals (FIG. 6 in A to I therein). COP-210, COP-211, and COP-212 showed high adsorption efficiency for valuable metals such as gold (99%), platinum (94-96%), and palladium (99%) in standard solution 1. In a mixture of standard solution 1 and standard solution 2, gold (99%), platinum (96-99%), and palladium (99%) were still well captured, and copper (10-30%) was highly adsorbed. High adsorption of silver (51-66%) and copper (10-30%) was observed in standard solution 2. Therefore, gold, platinum, palladium, silver, and copper were selected for additional adsorption studies using stock solutions.

Negative adsorption efficiency was observed for various elements, such as sodium, magnesium, aluminum, potassium, calcium, and the like. These metals are commonly found in water and experimental tools. Hafnium was unstable under these experimental conditions, and the concentration thereof increased after treatment. These elements were excluded for clarity of numerical results. Silver was also not included in FIG. 6 in A to C therein. This is because insoluble silver chloride may be formed between silver and HCl, which is the matrix component of standard solution 1, when two standard solutions are mixed.

Each COP was treated with a single metal solution of gold, platinum, palladium, silver, or copper at a high concentration of 3000 ppm. The adsorbent was treated with a spiked metal solution to maximize the capacity thereof. Then, the amount of metal that was adsorbed was measured through ICP-MS (Table 2). It was observed that the amount of gold that was adsorbed was the highest, at about 30 wt %. 8 wt % or more of each of platinum, palladium, and silver was loaded on the COP. Such high metal loading demonstrated effective single-metal adsorption to the developed COP for these metals. The COP also captured copper, but as shown in the selectivity test results, adsorption thereof was less effective, so the adsorption amount was measured to be 1.3-2.9 wt %.

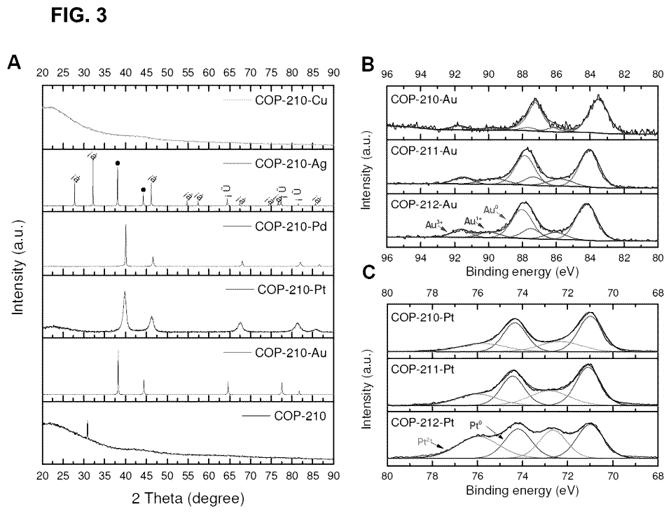

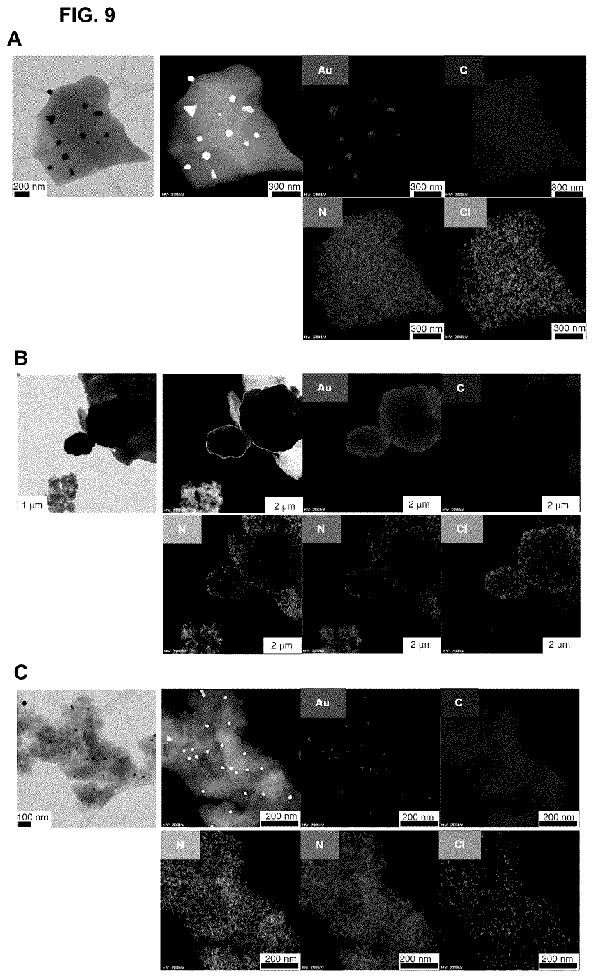

Reductive uptake was observed for high selectivity of the preferred metal in powder X-ray diffraction (XRD) analysis. The XRD pattern of the metal-loaded COP clearly showed the formation of gold, platinum, palladium, and silver nanoparticles (FIG. 3 in A therein). Silver chloride was also found in the COP containing silver. This is because chloride remains in the adsorbent due to the use of aluminum chloride for polymer synthesis. The metal nanoparticle sizes in the Scherrer equation were 11.1-12.2 nm, 9.8-11.8 nm, 11.1-11.3 nm, and 24.3-36.3 nm for the COPs containing gold, platinum, palladium, and silver, respectively. However, larger gold particles having sizes corresponding to ones of micrometers were also observed in transmission electron microscope (TEM) images (FIG. 9 in A to C therein).

X-ray photoelectron spectroscopy (XPS) data also suggested the metal reduction mechanism (FIG. 3 in B and C therein). The XPS spectrum of COP-210-Au shows three oxidation states of gold: 0 at 83.53 (4f_{7/2}) and 87.23 (4f_{5/2}) eV, +1 at 85.98 and 89.78 eV, and +3 at 87.68 and 91.78 eV, which means that the +3 state of gold ions is reduced to +1 and 0 states. The adsorbent also reduced platinum ions with slightly lower reduction potentials than gold ions (AuCl₄⁻+3e⁻->Au+4Cl⁻, +1.002 V [PtCl₄]²⁻+2e^{-->Pt+}4Cl^{-,} +0.755 V). The XPS spectrum of COP-210-Pt shows two oxidation states: 0 at 70.98 (4f_{7/2}) and 74.33 (4f_{5/2}) eV and +2 at 72.33 and 75.78 eV (D. R. Lide, CRC Handbook of Chemistry and Physics, CRC Press, Boca Raton, FL 2004; J. F. Moulder et al., Handbook of X-ray Photoelectron Spectroscopy, Perkin-Elmer Corporation, Minnesota 1992). As mentioned above, valuable metals such as gold, platinum, palladium ([PdCl₄]⁻+2e^{-->Pd+}4Cl⁻; +0.591 V), and silver (Ag⁺+e⁻->Ag, +0.7996 V) have higher reduction potentials than other typical metals, resulting in higher adsorption efficiencies for these metals in metal selectivity tests. Therefore, the developed COPs were capable of adsorbing these metals first through chelation and then further through the reduction mechanism. The metals may also be adsorbed through chemical bonding with polymer structures because gold ions in +3 and +2 states and platinum ions in +2 states were found in XPS studies, but it is not clear which functional groups these metals interacted with.

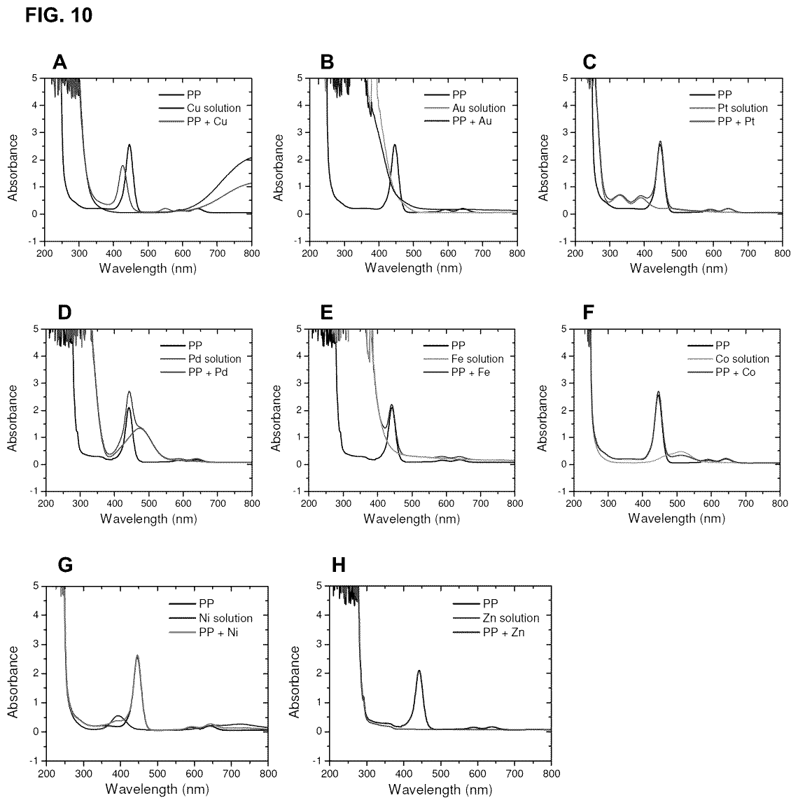

Copper is not a metal having a high reduction potential (Cu²⁺+2e⁻->Cu, +0.3419 V) like the valuable metals mentioned above, and was captured by the COP having moderate affinity in the metal selectivity test. In the XRD pattern of the copper-containing COP, when the adsorbent was treated with a high-concentration copper solution, copper was contained in an amount of 1.3-2.9%, but no peaks corresponding to metallic copper particles were observed. Copper ions were expected to be bound by the polymer structure, particularly at the porphyrin site. In order to confirm this result, a porphyrin solution was prepared and allowed to react with a solution of each of gold, platinum, palladium, copper, iron, cobalt, nickel, and zinc. A water-soluble porphyrin, namely 5,10,15,20-tetra(4-pyridyl)-21H,23H-porphyrin, was used because of the extremely low solubility of meso-tetraphenylporphyrin in water. The porphyrin solution was mixed with the metal solution and stirred for 24 hours, after which the absorbance of the mixture in the ultraviolet and visible light (UV/vis) ranges was measured. The color change was observed only in the solution of copper and porphyrin, and the porphyrin peak shifted from 446 nm to 427 nm only when copper and porphyrin were mixed. No peak shifts were observed in the solutions of other metals and porphyrin. The peak shift of the mixture of copper and porphyrin means that the copper ion is bound by a porphyrin ring to form metalloporphyrin. Iron, cobalt, nickel, and zinc were selected for this test because the atomic numbers thereof are close to copper and the ionic sizes are similar to each other. However, unlike copper, these metals did not interact with porphyrin because no shift was observed in the UV/vis absorption spectrum. Since gold ions were reduced upon reaction with the porphyrin monomer, changes in UV/vis absorption of the mixture of porphyrin and gold could not be observed (FIG. 10 in A to H therein).

### Example 3: Gold Adsorption and Desorption of COP

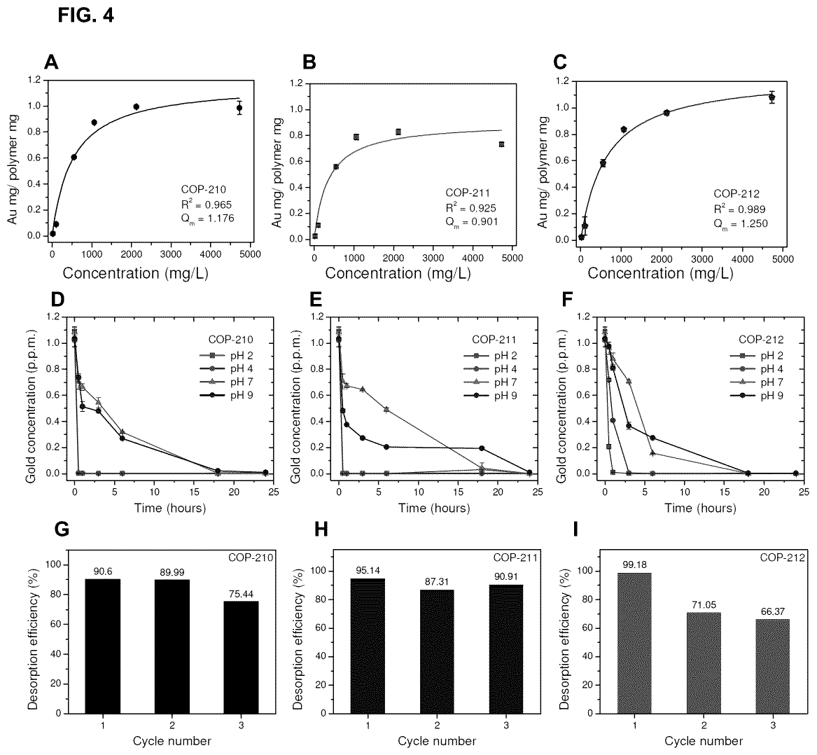

The gold adsorption capacity was measured to be 1.176, 0.901 and 1.250 g/g for COP-210, COP-211 and COP-212, respectively (FIG. 4 in A to C therein). The theoretical gold adsorption amount may be calculated as a percentage of the amount of nitrogen from elemental analysis results, and the corresponding values are 0.241, 0.222, and 0.210 g/g for COP-210, COP-211, and COP-212, respectively. Compared to the theoretical gold adsorption amount, the observed gold adsorption amount was very high, suggesting that the gold recovery process is mainly involved in gold capture. The very low value of the Langmuir constant (K_{L}) indicates low affinity between the adsorbent and the adsorbate supporting the gold reduction mechanism (Table 4). This adsorption capacity was high compared to many other reported gold adsorbents (Table 6). Effective gold adsorption by the developed COPs was observed at various pH values of the gold solution. Consequently, it was found that the COPs capture gold ions more effectively at low pH and thus adsorb 99% or more of gold ions within 30 minutes, but that the basic pH has a negative effect on gold capture. This is probably due to gold ion speciation from Au chloride ions to hydroxide complexes at higher pH, and anionic repulsion may occur between gold hydroxide and deprotonated porphyrin units in the polymer structure. This repulsive force also prevents reductive capture because no adsorption occurs. The three polymers showed similar trends in gold adsorption in the tested pH range of 2-9 (FIG. 4 in D to F therein).

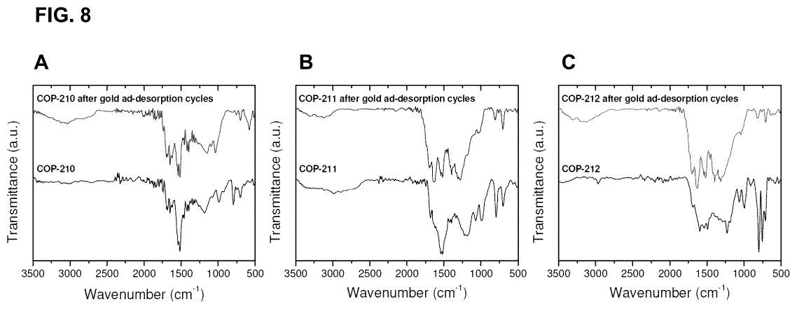

For efficient recovery of valuable metals, the adsorbed metal has to be separated from the adsorbent. Metals may exist in the form of nanoparticles, ions bound to porphyrin, or both. In any case, it was expected that strong acids and chelating reagents such as thiourea could help desorption. Desorption conditions such as desorption solution, temperature, desorption time, and the like should be as mild as possible so that the adsorbent may be regenerated and reused in the next cycle. Thiourea is a good alternative to cyanide, which is a highly toxic reagent typically used for gold leaching in the gold mining and recovery industries. Therefore, a mixture of dilute strong acids (HCl and HNO₃) and thiourea was used for metal desorption, and the solution was heated to 40° C. Under these conditions, gold adsorbed to the polymer was effectively recovered with desorption efficiency of 87-99%. After the third cycle, structures thereof were confirmed through comparison of FT-IR spectra beforehand and afterwards, and slight changes were observed compared to the spectra of pristine COPs (FIG. 8 in A to C therein). As the cycle progressed, desorption efficiency decreased due to the gold remaining in the polymer structure. In contrast, the efficiencies of desorption of platinum, palladium, and copper were 20-35%. As described above, these metals exist in the form of particles or ions, and the metal ions are strongly bound to the polymer structure and do not appear to be easily desorbed. Almost all of the gold is reduced to form particles of various sizes, and may be more readily dissolved in desorption reagents. Similarly, silver was more readily recovered using a mixture of HNO₃ and thiourea (Table 3(a)). When the gold adsorption and desorption processes were repeated, desorption efficiency decreased for three consecutive cycles. This is because gold is trapped in the polymer after the desorption process. As the cycle progressed, the amount of gold that was adsorbed increased, indicating that the polymer did not lose gold adsorption capability during the cycles (FIG. 4 in G to I therein and Table 3(b)).

TABLE 3
(a) Efficiency of desorption of metal-loaded COPs under
different conditions, (b) Gold adsorption, desorption
amount, and desorption efficiency in three adsorption/desorption
processes of COP-210, COP-211, and COP-212
(a)

| Desorption | |
|---|---|
| conditions | 0.1M SC(NH₂)₂ + 1M HCl + 1M HNO₃ (40° C., 24 h) |
| COP-210-Au | 92.15 |
| COP-211-Au | 87.67 |
| COP-212-Au | 99.98 |
| COP-210-Pt | 24.73 |
| COP-211-Pt | 35.25 |
| COP-212-Pt | 23.4 |
| COP-210-Pd | 31.8 |
| COP-211-Pd | 34.04 |
| COP-212-Pd | 33.62 |
| COP-210-Cu | 28.89 |
| COP-211-Cu | 21.50 |
| COP-212-Cu | 20.81 |
| Desorption | |
| conditions | 0.1M SC(NH₂)₂ + 1M HNO₃ (40° C., 24 h) |
| COP-210-Ag | 100 |
| COP-211-Ag | 100 |
| COP-212-Ag | 100 |

(b)

| | Cycle | Adsorption | Desorption | Desorption |
|---|---|---|---|---|
| Sample | number | amounts (%) | amounts (%) | efficiency (%) |
| COP-210 | 1 | 30.61 | 29.12 | 90.6 |
| | 2 | 38.57 | 34.71 | 89.99 |
| | 3 | 50.28 | 37.93 | 75.44 |
| COP-211 | 1 | 31.73 | 28.75 | 95.14 |
| | 2 | 36.89 | 32.21 | 87.31 |
| | 3 | 47.62 | 43.29 | 90.91 |
| COP-212 | 1 | 30.03 | 29.78 | 99.18 |
| | 2 | 42.01 | 29.85 | 71.05 |
| | 3 | 49.03 | 32.54 | 66.37 |

TABLE 4
Information on gold adsorption Langmuir isotherms
of COP-210, COP-211, and COP-212

| | Gold adsorption capacity | | Langmuir constant |
|---|---|---|---|
| | (g g⁻¹) | R² | (K_{L}, L mg⁻¹) |
| COP-210 | 1.176 | 0.965 | 0.00195 |
| COP-211 | 0.901 | 0.925 | 0.0029 |
| COP-212 | 1.250 | 0.989 | 0.00158 |

TABLE 6
Comparison of metal adsorption performance with other reported adsorbents

| | | Gold | | | | |
|---|---|---|---|---|---|---|
| | | adsorption | Tested | Gold | | |
| | | Capacity | metals for | adsorption | Gold desorption | |
| No. | Adsorbent | (g [symbol] /g) | selectivity | Kinetics | and reusability | Reference |
| 1 | COP-210 | 1.176 | 31 metals | 30 min | 3 cycles | This study |
| 2 | COP-211 | 0.901 | 31 metals | 30 min | 3 cycles | This study |
| 3 | COP-212 | 1.250 | 31 metals | 1 h | 3 cycles | This study |
| 4 | Thiourea- | 3.152 | ND | 2 h | ND | Chen et |
| | modified | | | | | al.^{[1]} |
| | polyethylenimine | | | | | |
| | copolymer | | | | | |
| 5 | Crosslinked | 1.52 | Au(III), Pd(II), | More than | ND | Inoue et |
| | persimmon | | Pt(IV), Cu(II), | 30 h at | | al.^{[2]} |
| | tannin gel | | Fe(III), Ni(II), | 293 K | | |
| | | | Zn(II) | | | |
| 6 | Cross-linked | 1.491 | Au, Pt, Pd, | 40 h st | ND | Inoue et |
| | polysaccharide gels | | Fe, Cu | 293 K | | al.^{[3]} |
| 7 | Poly(Cys-g-Sty) | Au(III)-1.345, | Au(III), Pt(IV), | 18 h for | 99% in 1st | Endo et |
| | | Pt(IV)-0.701, | Pd(III), Co(II), | Au, 1 min | cycle and 68% | al.^{[4]} |
| | | Pd(II)-0.442 | Ni(II), Zn(II), | for Pt and | in 2nd cycle | |
| | | | Mn(II) | Pd | | |
| 8 | BTU-PT gel | Au(III)-1.02, | Au(III), Pd(II), | 6 h for Au(III), | 5 cycles | Inoue et |
| | | Pd(II)-0.192, | Pt(IV), Cu(II), | 12 h for | | al.^{[5]} |
| | | Pt(IV)-0.131 | Fe(III), Ni(II), | Pd(II) and | | |
| | | | Zn(II) | Pt(IV) | | |
| 9 | PE/PP-g- | 0.9493 | Au(III), Cu(II), | 96% | 5 cycles | Li et |
| | PDMAEMA | | Fe(III), Ni(II), | within 1 h | | al.^{[6]} |
| | | | Pb(II) | | | |
| 10 | Fe-BTC/PpPDA | 0.934 | Au, Cu, Ni, | 2 min | 3 regeneration | Queen et |
| | | | Ca, Mg, K, Na | | cycles | al.^{[7]} |
| 11 | BT-SiO₂ | 0.642 g/g at | Au, Pb, Ni, | 30 min | 73% | Shi et |
| | | 323 K | Cu, Zn | | | al.^{[8]} |
| 12 | UiO-66-NH₂ | Au(III)-0.495, | Co(II), Ni(II), | 3 h for 100 | 5 cycles | Yun et |
| | | Pt(IV)-0.193, | Cu(II), Zn(II) | ppm Au(III), | | al.^{[9]} |
| | | Pd(II)-0.167 | | Pt(IV), Pd(II) | | |
| 13 | UiO-66 | Au(III)-0.280, | Co(II), Ni(II), | 25 min for | 5 cycles | Yun et |
| | | Pt(IV)-0.168, | Cu(II), Zn(II) | 100 ppm | | al.^{[9]} |
| | | Pd(II)-0.120 | | Au(III), | | |
| | | | | Pt(IV), Pd(II) | | |
| 14 | COP-122-ao | 0.4567 | 15 common | 10 min | ND | Yavuz et |
| | | | metals | | | al.^{[10]} |
| 15 | 3D bioMOF | 596 mg of | Au, Pd, Ni, | 30 min | ND | Pardo et |
| | | AuCl₃/1 g | Cu, Zn, Al | | | al.^{[11]} |
| | | of adsorbent | | | | |
| | | (0.389 g/g) | | | | |
| 16 | NH₂-MCM-41 | 0.275 | Au, Cu, Fe, | N/A | 5 cycles | Yeung et |
| | | | Pd, Pt | | | al.^{[12]} |
| 17 | SH-MCM-41 | 0.195 | Au, Cu, Fe, | N/A | 5 cycles | Yeung et |
| | | | Pd, Pt | | | al.^{[12]} |
| 18 | DTGA-XAD-16 | 0.035 | Au, Ni, Cu, | 3 h | 4 cycles | Kumar et |
| | | | Sn, Fe, Cr, | | | al.^{[13]} |
| | | | Se, Zn, Pb, | | | |
| | | | Ba, As, Y | | | |
| 19 | MNP-G3 | Pd(IV)- | Au(III), Pd(II), | 90% of | 6 cycles of | Lien et |
| | | 0.00362, | Pd(IV), Ag(I), | Au within | Pd(IV) | al.^{[14]} |
| | | Au(III)- | Zn(II) | 6 h | desorption | |
| | | 0.00360, | | | | |
| | | Pd(III)- | | | | |
| | | 0.00275, | | | | |
| | | Ag(I)- | | | | |
| | | 0.00284 | | | | |
| 20 | Imi-SBA-15 | Pt-0.0176, | Pt, Pd, Cu, | Pt and Pd | Pt-71.45%, | Yi et |
| | | Pd-0.00968 | Ni, Cd | adsorption | Pd-60.32% | al.^{[15]} |
| | | | | within 6 h | | |

[symbol]

indicates data missing or illegible when filed

[1] Y. Li et al., Green Chem. 2014, 16, 4875-4878.

[2] M. Gurung et al., Chem. Eng. J. 2011, 174, 556-563.

[3] B. Pangeni et al., Green Chem. 2012, 14, 1917-1927.

[4] H. Akbulut et al., RSC Adv. 2016, 6, 108689-108696.

[5] M. Gurung et al., Ind. Eng. Chem. Res. 2012, 51, 11901-11913.

[6] X. Liu et al., J. Appl. Polym. Sci. 2017, 134.

[7] D. T. Sun et al., J. Am. Chem. Soc. 2018, 140, 16697-16703.

[8] X. Huang et al., J. Hazard. Mater. 2010, 183, 793-798.

[9] S. Lin et al., J. Mater. Chem. A 2017, 5, 13557-13564.

[10] N. A. Dogan et al., ACS Sustain. Chem. Eng. 2018, 7, 123-128.

[11] M. Mon et al., J. Am. Chem. Soc. 2016, 138, 7864-7867.

[12] K. F. Lam et al., Chem. Eng. J. 2008, 145, 185-195.

[13] A. B. Kanagare et al., Ind. Eng. Chem. Res. 2016, 55, 12644-12654.

[14] C.-H. Yen et al., J. Hazard. Mater. 2017, 322, 215-222.

[15] T. Kang et al., J. Mater. Chem. 2004, 14, 1043-1049

### Example 4: Application of COP-212 to E-Waste For Gold Recovery

PCBs were obtained from local garbage sources. The metals in PCBs were leached according to a modification of a method described in the literature (U. Jadhav et al., Sci. Rep. 2015, 5, 1). Specifically, PCBs were soaked in a 10 M NaOH solution for one day to remove epoxy from the surface thereof. The PCBs were taken out and washed with tap water. The PCBs were then soaked in 4 L of 1 M HCl and HNO₃ solution. The temperature of the solution was raised to 40° C. and maintained for two days. The PCBs were taken out and filtered with an acidic solution to remove undissolved portions. KOH was added to the solution to reach a positive pH value, and DIW was added thereto to make 5 L of a final solution. 50 mg of COP-212 was added to 100 g of the solution, and the mixture was stirred for 24 hours. After filtration, COP-212 was washed thoroughly with DIW. The metal loaded on COP-212 was analyzed through ICP-MS after the polymer was dissolved using a microwave oven. The amount of metal in the polymer solution was compared with the metal concentration in the solution before addition of COP-212.

### Gold Adsorption Isotherm

Gold solutions at 20, 100, 500, 1000, 2000, and 5000 ppm were prepared from gold stock solutions. After 10 mg of the COP was added to the solution at each concentration, the mixture was stirred at 8 rpm for 48 hours. The COP was separated using a syringe filter device. The gold concentration was measured through ICP-MS, and the adsorption amount at each concentration was calculated as follows.

$$Gold adsorption amount ( Au mg / polymer mg ) = \frac{{Q}_{i} - {Q}_{e} ( mg )}{Polymer ( mg )} \qquad ( 1 )$$

Here, Qᵢ is the amount of gold in the initial solution, and Qₑ is the equilibrium state.

Gold adsorption isotherms were fitted to the Langmuir adsorption model. The equation of the Langmuir model is shown below.

$${Q}_{e} = \frac{{Q}_{m} \cdot {K}_{L} \cdot {C}_{e}}{1 + {K}_{L} \cdot {C}_{e}} \qquad ( 2 )$$

Here, Qₑ (gAu/gAds) is the amount of metal ion adsorbed to 1 g of adsorbent at equilibrium, Cₑ (mg/L) is the equilibrium concentration, Qₘ (gAu/gAds) is the maximum amount of metal ion adsorbed to 1 g of adsorbent, and K_{L} is the Langmuir constant.

Qₘ, K_{L}, and R₂ are derived from the aforementioned equations and are summarized in Table 4.

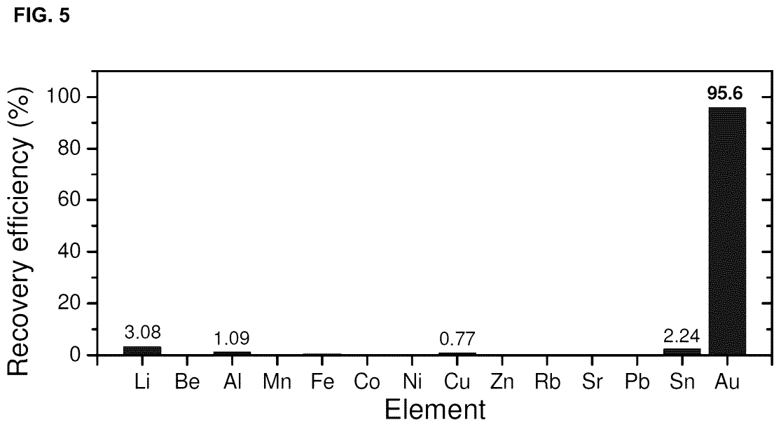

Finally, COP-212 exhibited the greatest gold adsorption capacity among the three porous polymers, and the efficiency thereof in recovering gold from actual e-waste was tested. To make a treatment solution, metals on recovered printed circuit boards (PCBs) were dissolved in strong acids. COP-212 was added to the prepared e-waste solution, followed by tumbling for 24 hours. Although the gold concentration was very low compared to other metals, COP-212 successfully captured gold with quantitative adsorption efficiency close to 95.6% (FIG. 5 and Table 5). As shown in FIG. 5, it is suggested that the COP of the present invention can be applied in practice to selective gold recovery from metal leachate of e-waste in which transition metal cations are present.

TABLE 5
Metals found in e-waste leachate and concentration
and recovery efficiency thereof

| No. | Element | Amount (mg) | Recovery efficiency (%) |
|---|---|---|---|
| 1 | Li | 0.576056 | 3.081462 |
| 2 | Be | 0.181654 | 0.00777 |
| 3 | Al | 53.17235 | 1.091188 |
| 4 | Mn | 0.547514 | 0.038306 |
| 5 | Fe | 23.30696 | 0.385854 |
| 6 | Co | 0.154849 | 0.020668 |
| 7 | Ni | 18.2054 | 0.0085 |
| 8 | Cu | 300.2124 | 0.769436 |
| 9 | Zn | 183.1189 | 0.005039 |
| 10 | Rb | 0.276527 | 0.011937 |
| 11 | Sr | 0.157433 | 0.032952 |
| 12 | Pb | 44.31674 | 0.00099 |
| 13 | Sn | 10.30994 | 2.239779 |
| 14 | Au | 0.389511 | 95.59328 |

### Example 5: Analysis of Pore Structure of COP and Gas Adsorption Experiment

Carbon dioxide (CO₂), methane (CH₄), and hydrogen (H₂) adsorption capabilities were studied to evaluate gas separation capability of the porous polymers of Example 1.

Porosity characterization of the polymers was performed on argon adsorption isotherms using a Micromeritics 3FLEX accelerated surface area and porosimetry analyzer at 87 K. The samples were degassed in a vacuum at 423 K for 6 hours before measurement. The specific surface area was determined through the BET method. All pore size distributions were calculated using Micromeritics 3FLEX software and an NLDFT model with slit pores.

The adsorption and desorption of CO₂ and CH₄ were performed at 273 K and 298 K, respectively, and H₂ processing was performed at 77 K after degassing the sample before each measurement.

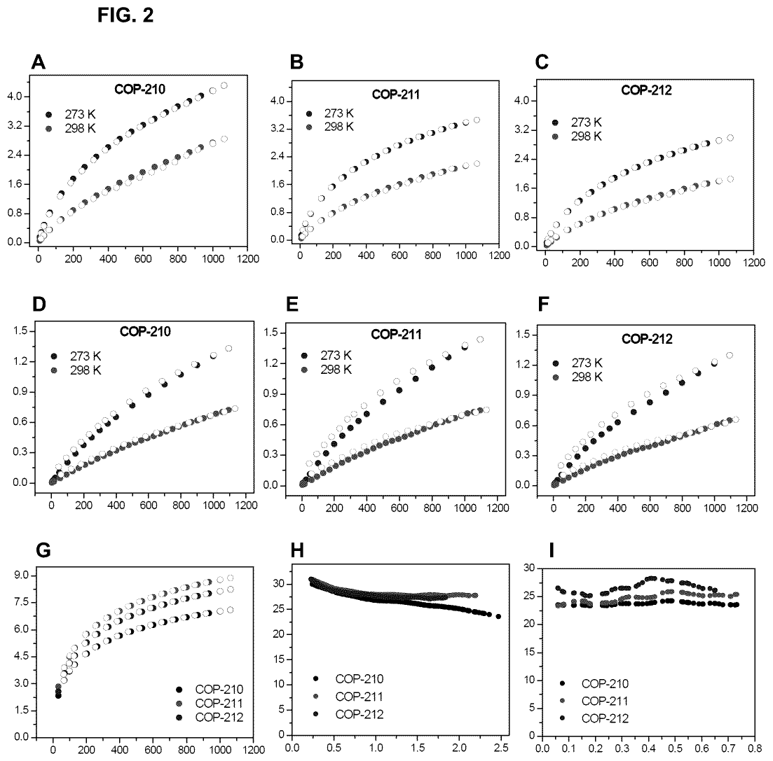

The CO₂ adsorption isotherms did not show hysteresis, indicating mainly physisorptive binding with capacities ranging from 3.01 to 4.30 mmol/g at 273 K and 1.1 bar (Table 1 and FIG. 2 in A to I therein). The CO₂ adsorption enthalpy (Qₛₜ) was calculated from the adsorption isotherms at 273 and 298 K. These COPs have similar CO₂ hydrophilic porphyrin chemistry and thus show similar Qₛₜ values (30-31 kJ/mol). Therefore, the CO₂ uptake capacity thereof was directly correlated with the total BET surface area. The larger the surface area, the higher the CO₂ capacity. This value is similar to or better than that of a nitrogen-rich and highly porous structure such as BILP-6 (Table 7 for comparison) (M. G. Rabbani et al., Chem. Mater. 2012, 24, 1511; D. Thirion et al., J. Org. Chem. 2016, 12, 2274; 0. Buyukcakir et al., Chem.-Eur. J. 2015, 21, 15320). The H₂ adsorption isotherm measured at 77 K shows a trend similar to that of CO₂. The adsorption capacity at 1.1 bar is linearly correlated with the BET surface area of the material. The adsorption capacities of the main materials in H₂ adsorption vary from 7.11 mmol/g (COP-212) to 8.88 mmol/g (COP-210) (Table 7 for comparison). For example, COP-210 stores more H₂ than materials having large surface areas such as COF-102 (3530 m²/g, 5.96 mmol/g) (H. Furukawa et al., J. Am. Chem. Soc. 2009, 131, 8875). Considering the scalable and inexpensive production thereof, these COPs are promising materials in the field of hydrogen storage.

Similarly, the porous polymers showed good performance in CH₄ adsorption with capacity up to 1.44 mmol/g (COP-210) at 273 K and 1.1 bar. In order to counteract the possibility of swelling behavior previously reported for alkyl-linked porous polymers, pressure slightly higher than 1 bar (maximum pressure) was studied (V. Rozyyev et al., Nat. Energy 2019, 4, 604). DCE-linked COP-212 had higher binding energy (Qₛₜ=27 kJ/mol) than DCM-linked COP-210 and chloroform-linked COP-211 (Qₛₜ=24 kJ/mol) when CH₄ Qₛₜ values were calculated. This is due to the previously reported methane-affinity dimethylene framework (V. Rozyyev et al., Nat. Energy 2019, 4, 604). Consequently, COP-212 had lower surface area and micropore volume than COP-210 but exhibited methane adsorption similar thereto. Surprisingly, despite the relatively low surface area and low Qₛₜ values, COP-211 had the highest CH₄ uptake capacity, presumably due to the highly crosslinked tridentate linker. It should be noted that CH₄ has a larger kinetic diameter (0.38 nm) than CO₂ (0.33 nm) and H₂ (0.29 nm). Therefore, CH₄ adsorption may be more sensitive to pore size than CO₂ and H₂.

TABLE 7
Comparison of gas adsorption performance of COP with other reported adsorbents

| | | | CO₂ uptake at | CH₄ uptake at | H₂ uptake at | |
|---|---|---|---|---|---|---|
| | SA_{BET} | | 273K, 1.1 bar | 273K, 1.1 bar | 77K, 1.1 bar | |
| Adsorbent | (m² g⁻¹) | Chemistry | (mmol g⁻¹) | (mmol g⁻¹) | (mmol g⁻¹) | Reference |
| COP-210 | 856 | Porphyrin, alkyl | 4.3 | 1.33 | 8.88 | This work |
| COP-211 | 790 | Porphyrin, alkyl | 3.47 | 1.44 | 8.24 | This work |
| COP-212 | 685 | Porphyrin, alkyl | 3.01 | 1.30 | 7.11 | This work |
| BILP-2 | 708 | Benzimidazole | 3.32 | 0.87 | 6.45 | El-Kaderi et al.^{[16]} |
| BILP-6 | 1261 | Benzimidazole | 4.79 | 1.68 | 10.9 | El-Kaderi et al.^{[16]} |
| CuPor-BDPC | 442 | Porphyrin, imine | 1.25 | 0.20 | 1.98 | Echegoyen et al.^{[17]} |
| PAF-1 | 5600 | Aromatic | 2.05 | 1.25 | 7.5 | Ben et al.^{[18]} |
| PIM-1 | 740 | Nitrile, aromatic | 2.53 | 0.82 | 4.71 | Song et al.^{[19]} |
| | | ether | | | | |
| TATHCP | 997 | Alkyl carbazole, | 2.85 | 0.97 | 6.45 | Sadak et al.^{[20]} |
| | | aromatic | | | | |
| COF-1 | 750 | Boronate, aromatic | 1.18 | ND | 5.36 | Furukawa et al.^{[21]} |
| COF-102 | 3620 | Boronate, aromatic | 0.84 | 0.94 | 6.25 | Furukawa et al.^{[21]} |
| BPL carbon | 1250 | Carbon | 1.77 | ND | 7.82 | Furukawa et al.^{[21]} |
| PECONF-3 | 851 | Phosphazene, | 3.3 | 0.6 | ND | Mohanty et |
| | | aromatic | | | | al.^{[22]} |

[16] M. G. Rabbani et al., Chem. Mater. 2012, 24, 1511-1517.

[17] V. S. P. K. Neti et al., Polym. Chem. 2013, 4, 4566-4569.

[18] T. Ben et al., Energy Environ. Sci. 2011, 4, 3991-3999.

[19] Q. Song et al., Nat. Commun. 2014, 5, 1-12.

[20] A. E. Sadak et al., ACS Appl. Energy Mater. 2020, 3, 4983-4994.

[21] H. Furukawa et al., J. Am. Chem. Soc. 2009, 131, 8875-8883.

[22] P. Mohanty et al., Nat. Commun. 2011, 2, 1-6.

### INDUSTRIAL APPLICABILITY

As is apparent from the above description, a porous porphyrin-based covalent organic polymer according to the present invention exhibits high adsorption selectivity for valuable metals such as gold, platinum, palladium, and silver, and thus can be applied to the recovery of valuable metal elements from metal leachate of e-waste or natural river water or seawater, and can also be used for selective gas separation due to high selectivity for carbon dioxide (CO₂), methane (CH₄), and hydrogen (H₂).

In addition, a method of preparing the porous covalent organic polymer can be performed through simple and rapid one-pot polymerization without the need for a heating step or a purification step under conditions of room temperature and atmospheric pressure. Because a Lewis acid catalyst, a monomer, and a chlorinated solvent, which are readily available and inexpensive, are used, preparation costs are low and large-scale industrial production is possible.

Therefore, selective gas and metal capture using the developed polymer, which is imparted with microporosity and porphyrin functions and prepared at low cost, is very industrially effective.

Although specific embodiments of the present invention have been disclosed in detail above, it will be obvious to those skilled in the art that the description is merely of preferable exemplary embodiments and is not to be construed as limiting the scope of the present invention. Therefore, the substantial scope of the present invention will be defined by the appended claims and equivalents thereof.

1. A porphyrin-based covalent organic polymer represented by Chemical Formula 1, Chemical Formula 2, or Chemical Formula 3: 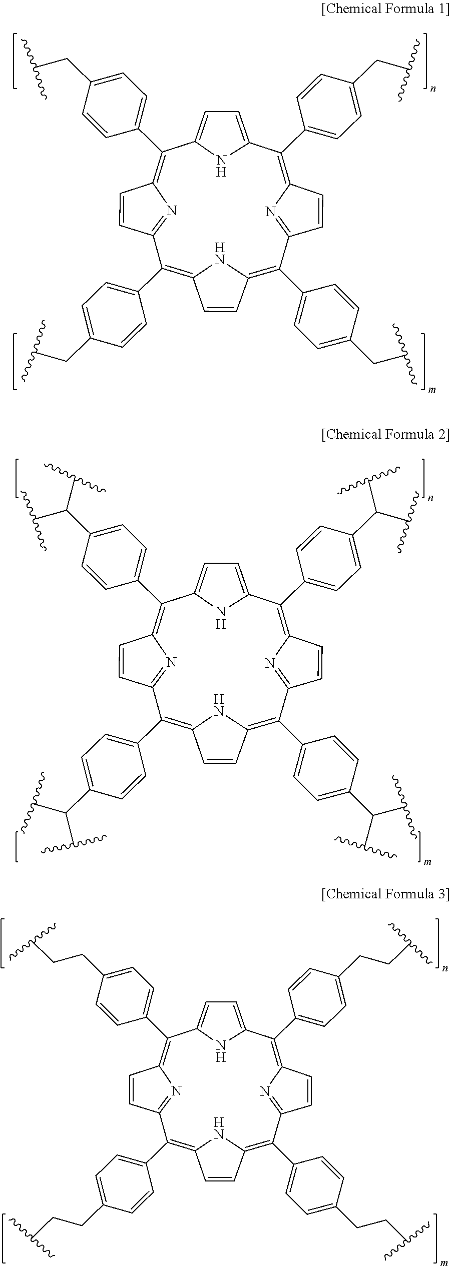
in Chemical Formula 1, Chemical Formula 2, and Chemical Formula 3, m and n are numbers of repeating units, m is an integer from 500 to 400,000, and n is an integer from 500 to 400,000.

2. The porphyrin-based covalent organic polymer of claim 1, having a specific surface area of 500-856 m²/g, a microporosity of 84-92%, a particle size of 100 nm-1,000 μm, and a pore size of 0-6 nm.

3. A method of preparing the porphyrin-based covalent organic polymer of claim 1, the method comprises: adding a tetraphenylporphyrin monomer and a chlorinated solvent in presence of a Lewis acid catalyst and then performing a Friedel-Crafts polymerization reaction to obtain a porous covalent organic polymer represented by Chemical Formula 1, Chemical Formula 2, or Chemical Formula 3: 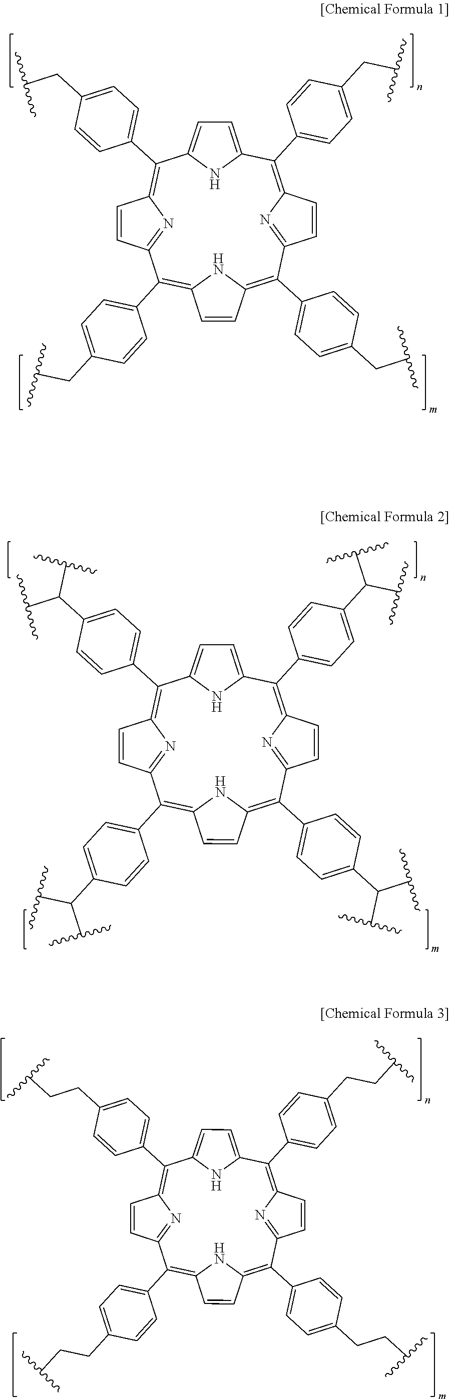
in Chemical Formula 1, Chemical Formula 2, and Chemical Formula 3, m and n are numbers of repeating units, m is an integer from 500 to 400,000, and n is an integer from 500 to 400,000.

4. The method of preparing the porphyrin-based covalent organic polymer of claim 3, wherein the chlorinated solvent is dichloromethane, chloroform, or 1,2-dichloroethane.

5. The method of preparing the porphyrin-based covalent organic polymer of claim 3, wherein the chlorinated solvent is added in an amount of 2,000 to 3,000 parts by weight based on 100 parts by weight of the tetraphenylporphyrin monomer.

6. The method of preparing the porphyrin-based covalent organic polymer of claim 3, wherein the chlorinated solvent is a linker connecting the tetraphenylporphyrin monomer.

7. The method of preparing the porphyrin-based covalent organic polymer of claim 3, wherein the reaction is carried out at 20 to 85° C. for 24 to 72 hours.

8. An adsorbent comprising the porphyrin-based covalent organic polymer of claim 1 or the porphyrin-based covalent organic polymer in which a metal is loaded.

9. A method of recovering a valuable metal element from a precious-metal-containing solution, the method comprises:
(a) adsorbing a valuable metal element to the adsorbent by adding the adsorbent comprising the porphyrin-based covalent organic polymer of claim 1 to a solution containing the valuable metal element; and
(b) desorbing and recovering the valuable metal element from the adsorbent to which the valuable metal element is adsorbed.

10. The method of recovering a valuable metal element of claim 9, wherein, in step (b), the adsorbent to which the valuable metal element is adsorbed is added to a mixed solution of acid and thiourea in order to desorb the valuable metal element.

11. The method of recovering a valuable metal element of claim 9, further comprising recirculating the adsorbent from which the valuable metal is desorbed to step (a), after step (b).

12. The method of recovering a valuable metal element of claim 9, wherein the valuable metal element is adsorbed to the adsorbent through irradiation with light in step (a).

13. The method of recovering a valuable metal element of claim 9, wherein the precious-metal-containing solution is seawater, wastewater from a plating plant, or a solution containing electronic waste.

14. The method of recovering a valuable metal element of claim 13, wherein the solution containing the electronic waste is obtained by removing a coating film from a substrate of the electronic waste, soaking the substrate from which the coating film is removed in an acid solution, performing filtration, and then adding a basic solution and desalted water to a filtered solution.

15. The method of recovering a valuable metal element of claim 9, wherein the valuable metal is selected from the group consisting of Au, Pt, Ag, Pd, Ru, Rh, Ir, Cu, and Re.

16. The method of recovering a valuable metal element of claim 9, wherein a pH of the solution is 2-9.

17. A method of separating carbon dioxide, methane, or hydrogen from a mixture of carbon dioxide, methane and hydrogen by contacting the adsorbent of claim 8 with the mixture of carbon dioxide, methane and hydrogen.
